(19) United States
(12) Patent Application Publication
(10) Pub. No.: US 2014/0302226 A1
(43) Pub. Date: Oct. 9, 2014

(54) PET FOOD COMPOSITION WITH A SOFT TEXTURE

(71) Applicants: Luis J. Montelongo, Lawrence, KS (US); David Kappelman, Olathe, KS (US)

(72) Inventors: Luis J. Montelongo, Lawrence, KS (US); David Kappelman, Olathe, KS (US)

(73) Assignee: HILL'S PET NUTRITION, INC., Topeka, KS (US)

(21) Appl. No.: 14/362,924

(22) PCT Filed: Dec. 15, 2011
(86) PCT No.: PCT/US2011/065039

§ 371 Date: Jun. 5, 2014

(51) Int. Cl. A23K 1/165; A23K 1/18

(52) U.S. Cl. CPC A23K 1/1653; A23K 1/1866
USPC 426/656

(57) ABSTRACT

Provided are pet food compositions having a soft texture. Also provided are methods for preparing soft textured pet food compositions in which mixtures comprising appropriate amounts of protein, fat, and carbohydrate are contacted with an amylase at a temperature to provide the desired degree of softening of the composition. The pet food compositions exhibit increased penetrating force and are substantially unchanged with respect to digestibility and stool formation as compared to pet food compositions without added amylase.

### FIELD OF THE INVENTION

The present invention relates to pet food compositions having a soft texture and processes for the preparation of soft-textured pet food compositions in which the starch component of the composition is partially digested with an amylase.

### BACKGROUND OF THE INVENTION

Pet food compositions are designed and formulated to provide a nutritionally complete diet for the animal for which the food is intended. Where the pet food is intended to serve as the primary if not sole source of nutrition for the animal, that food is to be formulated in compliance with very strict nutritional guidelines including, but not limited to, the levels of protein and fat in the pet food composition. One method for achieving the desired balance and relative concentrations of the required dietary components involves supplementation of the formulation with one or more carbohydrate components which generally comprise the polymeric materials amylose and amylopectin.

Pet food compositions, particularly “wet” pet food compositions, are prepared by combining appropriate sources of water, protein, fat, carbohydrate and other nutritionally-required ingredients identified in the art, and cooking that mixture at an appropriate temperature and for sufficient time to blend the ingredients. The cooked mixture is distributed to containers that are then sealed and retorted to sterilize the pet food composition. However, during and after these manipulative processes, the starch components can hydrate, swell, and gelatinize As the compositions cool, the starch polymers can rearrange, form intermolecular hydrogen bonds, and develop into relatively crystalline structures. This process, referred to as retrogradation, can create an undesirably firm structure in the final product which may be organoleptically-unacceptable as pet food.

Accordingly, there is a need for compositions that are both nutritionally and organoleptically acceptable as pet food compositions as well as for methods that can reproducibly provide those compositions.

### BRIEF SUMMARY

Soft-textured pet food compositions of the present disclosure are prepared according to a method in which a mixture comprising appropriate levels of water, protein, fat, and carbohydrate are treated with an amylase, particularly an endo-amylase, exo-amylase or mixtures thereof, to partially digest starch polymers of the mixture. The digestion can be performed either before or during the cook step, before the composition is subjected to the retorting process, or during the retorting process. The pet food compositions prepared in this manner are quantitatively softer than pet food compositions prepared in the same manner except for the amylase treatment.

In various embodiments, therefore, provided herein are soft-textured pet food compositions as well as methods for their preparation.

In one embodiment, the present disclosure provides a pet food composition comprising from about 10% to about 60% protein on a dry matter basis, from about 5% to about 40% fat on a dry matter basis, from about 30% to about 65% carbohydrate on a dry matter basis, and at least one amylase. The pet food compositions of this embodiment have a soft texture, as demonstrated by the observation that it has a penetrating force that is within the range of from about 10% to about 80% of that of a pet food composition without added amylase. The pet food composition without added amylase is one prepared in the same manner except for omission of the addition of an amylase. In one aspect of this embodiment, the amylase employed is an endo-amylase, an exo-amylase, or mixtures thereof and the final, soft-textured pet food composition comprises substantially no enzymatically-active amylase. In one specific embodiment, the amylase employed is a temperature-labile amylase and the final, soft-textured pet food composition comprises substantially no enzymatically-active amylase.

In certain aspects of this embodiment, the amylase is present at a level of from about 0.001% to about 0.1%, from about 0.005% to about 0.05%, or from about 0.01% to about 0.025% of the total weight of the composition.

In certain aspects of this embodiment, the soft-textured pet food composition is nutritionally, oroganoleptically or both nutritionally and oroganoleptically adapted for a companion animal. In certain aspects, that companion animal is a canine or feline.

In certain embodiments, the soft-textured pet foods disclosed herein have a penetrating force that is within the range of from about 10% to about 80%, from about 20% to about 70%, from about 10% to about 60%, from about 20% to about 60%, from about 10% to about 40%, or from about 20% to about 40% of that of a pet food composition without added amylase.

In a further embodiment, the soft-textured pet food composition of the present disclosure is a wet pet food composition comprising a level of water within the range of from about 30% to about 80%, from about 35% to about 65%, or from about 40% to about 60% of the total weight of the composition.

The present disclosure also provides a method for production of the soft-textured pet food compositions, the method comprising: (a) preparing a mixture comprising water, from about 10% to about 60% protein on a dry matter basis, from about 5% to about 40% fat on a dry matter basis, and from about 30% to about 65% carbohydrate on a dry matter basis; (b) contacting the mixture with an effective amount of an amylase and heating to a temperature from about 120° F. to about 220° F. for a time sufficient to provide an amylase-treated mixture; and (c) retorting the amylase-treated mixture, wherein the pet food composition has a soft texture, and wherein the soft-textured pet food composition has a penetrating force that is within a range of from about 10% to about 80% of that of a pet food composition without added amylase.

In one aspect of this embodiment, the amylase employed is an endo-amylase, an exo-amylase, or mixtures thereof.

In certain aspects of this embodiment, the amylase is present at a level of from about 0.001% to about 0.1%, from about 0.005% to about 0.05%, or from about 0.01% to about 0.025% of the total weight of the composition.

In another aspect of this embodiment, the mixture comprises a level of water of from about 30% to about 80%, from about 35% to about 65%, or from about 40% to about 60% of the total weight of the composition.

In still other embodiments, the disclosed method of preparation of the soft-textured pet food product provides a composition having a penetrating force that is within the range of from about 10% to about 80%, from about 20% to about 70%, from about 10% to about 60%, from about 20% to about 60%, from about 10% to about 40%, or from about 20% to about 40% of that of a pet food composition without added amylase.

The present disclosure is therefore also directed to soft-textured pet food compositions prepared according to the processes disclosed herein. In particular aspects of this embodiment, the soft-textured pet food composition is nutritionally, organoleptically or both nutritionally and organoleptically adapted for a companion animal. Is still further aspects of this embodiment, the companion animal is a canine or feline.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION

The following description of the preferred embodiment(s) is merely exemplary in nature and is in no way intended to limit the invention, its application, or uses.

The soft-textured pet food compositions prepared according to the methods disclosed herein are demonstrably softer than a pet food compositions without added amylase. The pet food composition without added amylase is one prepared in the same manner except for omission of the addition of an amylase. The disclosed soft-textured pet food compositions are also substantially unchanged as compared to pet food compositions without added amylase with respect to digestibility. The disclosed compositions also do not create gastrointestinal issues in animals fed these soft-textured pet food compositions as indicated by the absence of a substantial change in the nature of the stool produced by animals fed a soft textured pet food composition of the present disclosure.

In various embodiments, therefore, provided herein are soft-textured pet food compositions as well as methods for their preparation.

In one embodiment, the present disclosure provides a pet food composition comprising from about 10% to about 60% protein on a dry matter basis, from about 5% to about 40% fat on a dry matter basis, and from about 30% to about 65% carbohydrate on a dry matter basis, and at least one amylase. The pet food compositions of this embodiment have a soft texture, as demonstrated by the observation that it has a penetrating force that is within the range of from about 10% to about 80% of that of a pet food composition without added amylase. The pet food composition without added amylase is one prepared in the same manner except for omission of the addition of an amylase. In one aspect of this embodiment, the amylase employed is an endo-amylase, an exo-amylase, or mixtures thereof and the final, soft-textured pet food composition comprises substantially no enzymatically active amylase. In one specific embodiment, the amylase employed is a temperature-labile amylase and the final, soft-textured pet food composition comprises substantially no enzymatically active endo-amylase.

As contemplated herein, the compositions of the present invention may encompass nutritionally complete and balanced pet food compositions (also referred to herein simply as “nutritionally complete pet food compositions”). Nutritionally complete pet food compositions are familiar to one of skill in the art. For example, nutrients and ingredients such as those disclosed herein as well as others suitable for animal feed compositions, and recommended amounts thereof, may be found, for example, in the Official Publication of the Association of American Feed Control Officials (“AAFCO”), Inc., Nutrient Requirements of Dogs and Cats (2011). For example, nutritionally complete foods may contain protein, fat, carbohydrate, dietary fiber, amino acids, minerals, vitamins, and other ingredients in amounts known by those of skill in the art.

In addition to those components set forth in the Examples, protein may be supplied by any of a variety of sources known by those skilled in the art, including plant sources, animal sources, or both. Animal sources include, for example, meat, meat by-products, seafood, dairy, eggs, and the like. Meats include, for example, the flesh of poultry, fish, and mammals (e.g., cattle, pigs, sheep, goats, and the like). Meat by-products include, for example, lungs, kidneys, brain, livers, and stomachs and intestines (freed of all or essentially all their contents). The protein can be intact, almost completely hydrolyzed, or partially hydrolyzed.

In addition to those components set forth in the Examples, the fat can be supplied by any of a variety of sources known by those skilled in the art, including meat, meat by-products, fish oil, and plants. Plant fat sources include wheat, flaxseed, rye, barley, rice, sorghum, corn, oats, millet, wheat germ, corn germ, soybeans, peanuts, and cottonseed, as well as oils derived from these and other plant fat sources.

In addition to those components set forth in the Examples, the carbohydrate may be supplied by any of a variety of sources known by those skilled in the art, including oat fiber, cellulose, peanut hulls, beet pulp, parboiled rice, corn starch, corn gluten meal, and any combination of those sources. Grains supplying carbohydrate include, but are not limited to, wheat, corn, barley, and rice. Carbohydrate content of foods may be determined by any number of methods known by those of skill in the art. Generally, carbohydrate percentage may be calculated as nitrogen free extract (“NFE”), which may be calculated as follows: NFE=100%-moisture %-protein %-fat %-ash %-crude fiber %.

In certain embodiments of the present disclosure, the soft-textured pet food compositions may also comprise one or more fatty acids for inclusion selected from among omega 3 fatty acids such as docosahexanenoic acid (DHA), eicosapentaenoic acid (EPA), alpha-linolenic acid (ALA), octadecatetraenoic acid (stearidonic acid), or mixtures thereof.

In still other aspects of the present disclosure, the soft-texture pet food compositions may be formulated with dietary fiber. Dietary fiber refers to components of a plant which are resistant to digestion by an animal's digestive enzymes. Dietary fiber includes soluble and insoluble fibers. Soluble fiber are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fiber may be supplied by any of a variety of sources, including cellulose, whole wheat products, wheat oat, corn bran, flax seed, grapes, celery, green beans, cauliflower, potato skins, fruit skins, vegetable skins, peanut hulls, and soy fiber. Crude fiber includes indigestible components contained in cell walls and cell contents of plants such as grains, e.g., hulls of grains such as rice, corn, and beans.

In certain other aspects, the soft-textured pet food compositions of the disclosure may also be formulated with amino acids, including essential amino acids, which may be added to the compositions of the present invention as free amino acids, or supplied by any number of sources, e.g., crude protein, to the compositions of the present invention. Essential amino acids are amino acids that cannot be synthesized de novo, or in sufficient quantities by an organism and thus must be supplied in the diet. Essential amino acids vary from species to species, depending upon the organism's metabolism. For example, it is generally understood that the essential amino acids for dogs and cats (and humans) are phenylalanine, leucine, methionine, lysine, isoleucine, valine, threonine, tryptophan, histidine and arginine. In addition, taurine, while technically not an amino acid but a derivative of cysteine, is an essential nutrient for cats.

The compositions of the present invention may also contain one or more minerals and/or trace elements, e.g., calcium, phosphorus, sodium, potassium, magnesium, manganese, copper, zinc, choline, or iron salts, in amounts required to avoid deficiency and maintain health. These amounts are known by those of skill in the art, for example, as provided in the Official Publication of the Association of American Feed Control Officials, Inc. (“AAFCO”), Nutrient Requirements of Dogs and Cats (2011).

The compositions of the present invention may also include vitamins in amounts required to avoid deficiency and maintain health. These amounts and methods of measurement are known by those skilled in the art. For example, the Official Publication of the Association of American Feed Control Officials, Inc. (“AAFCO”), Nutrient Requirements of Dogs and Cats (2011) provides recommended amounts of such ingredients for dogs and cats. As contemplated herein, useful vitamins may include, but are not limited to, vitamin A, vitamin B1, vitamin B2, vitamin B6, vitamin B12, vitamin C, vitamin D, vitamin E, vitamin H (biotin), vitamin K, folic acid, inositol, niacin, and pantothenic acid.

The compositions of the present invention may additionally comprise additives, stabilizers, fillers, thickeners, flavorants, palatability enhancers and colorants in amounts and combinations familiar to one of skill in the art. In certain aspects of this embodiment, the soft-textured pet food composition is nutritionally, organoleptically or both nutritionally and organoleptically adapted for a companion animal. In certain aspects, that companion animal is a canine or feline.

In other aspects of this embodiment, the soft-textured pet food compositions of the present disclosure comprise substantially no enzymatically-active amylase.

In certain embodiments, the soft-textured pet foods disclosed herein have a penetrating force that is within the range of from about 10% to about 80%, from about 20% to about 80%, from about 10% to about 60%, from about 20% to about 60%, from about 10% to about 40%, or from about 20% to about 40% of that of a pet food composition without added amylase.

In a further embodiment, the soft-textured pet food composition of the present disclosure is a wet pet food composition comprising a level of water within the range of from about 30% to about 80%, from about 35% to about 65%, or from about 40% to about 60% of the total weight of the composition.

The present disclosure also provides a method for production of the soft-textured pet food compositions, the method comprising: (a) preparing a mixture comprising water, from about 10% to about 60% protein on a dry matter basis, from about 5% to about 40% fat on a dry matter basis, and from about 30% to about 65% carbohydrate on a dry matter basis; (b) contacting the mixture with an effective amount of an amylase and heating to a temperature from about 120° F. to about 220° F. for a time sufficient to provide an amylase treated mixture; and (c) retorting the amylase-treated mixture, wherein the pet food composition has a soft texture, and wherein the soft-textured pet food composition has a penetrating force that is within a range of from about 10% to about 80% of that of a pet food composition without added amylase.

In certain aspects of this embodiment, the amylase employed is an endo-amylase, exo-amylase, or mixtures thereof.

In certain aspects of this embodiment, the amylase is present at a level within the range of from about 0.001% to about 0.1%, from about 0.005% to about 0.05%, or from about 0.01% to about 0.025% of the total weight of the composition.

The amylase may be combined with the core ingredients, i.e., protein, fat, and carbohydrate during the initial blending steps, or may be added to the mixture after the initial blending steps (e.g., at a temperature of about 100° F.), but before initiation of the cooking steps at an elevated temperature (e.g., at a temperature within the range of from about 120° F. to about 220° F.). In other aspects, the amylase is added to the blend after initiation of the cooking step.

In other aspects of the methods disclosed herein, the amount of amylase, and the temperature and duration of the starch hydrolysis may be varied to provide a pet food composition having a desired softness of texture. In other aspects, the degree of desired softness of texture is a target level of softness that is exhibited by the pet food composition after curing for a substantial period of time, e.g., at least two weeks, to provide a product with an extended shelf life.

Amylases useful in the methods disclosed herein include, but are not to be limited to those set forth in the Examples. In certain embodiments, the amylase is a temperature-labile enzyme. In one aspect, this would be a level of enzyme that does not result in an increase in the softness of the composition upon extended storage or curing.

In another aspect, the amylase used in the methods disclosed herein is temperature-stable. In yet another aspect, the amylase is actually a mixture of enzymes designed to generate and maintain a defined level of softness of the texture of the pet food composition for an extended period of time subsequent to or after the retort process.

In another aspect of this embodiment, the mixture comprises a level of water within the range of from about 30% to about 80%, from about 35% to about 65%, or from about 40% to about 60% of the total weight of the composition.

In still other embodiments, the disclosed method of preparation of the soft-textured pet food product provides a composition having a penetrating force that is within the range of from about 10% to about 80%, from about 20% to about 80%, from about 10% to about 60%, from about 20% to about 60%, from about 10% to about 40%, or from about 20% to about 40% of that of a pet food composition without added amyalse.

The present disclosure is therefore also directed to soft-textured pet food compositions prepared according to the processes disclosed herein. In particular aspects of this embodiment, the soft-textured pet food composition is nutritionally, organoleptically or both nutritionally and organoleptically adapted for a companion animal. Is still further aspects of this embodiment, the companion animal is a canine or feline.

### EXAMPLES

### Example 1

### Effects of Partial Digestion of Starch on Pet Food Composition Texture

Four pet food compositions (Formula 1-Formula 4) were prepared according to the targeted ranges disclosed in Tables 1-4 below:

TABLE 1

| Ingredient | Amount (%) |
|---|---|
| Moisture | 77.6-78.4 |
| Protein | 3.8-4.5 |
| Fat | 1.6-2.2 |
| Ash | 1.0-1.1 |
| NFE | 12.4-13.0 |

The targeted ranges for the formulation of Formula 2 is present in Table 2 below:

TABLE 2

| Ingredient | Amount (%) |
|---|---|
| Moisture | 77.5-78.5 |
| Protein | 5.4-6.2 |
| Fat | 3.0-4.4 |
| Ash | 1.0-1.4 |
| NFE | 10.6-11.4 |

The targeted ranges for the formulation of Formula 3 is present in Table 3 below:

TABLE 3

| Ingredient | Amount (%) |
|---|---|
| Moisture | 77.0-79.0 |
| Protein | 5.5-7.1 |
| Fat | 3.2-6.7 |
| Ash | 1.3-2.2 |
| NFE | 7.9-9.6 |

The targeted ranges for the formulation of Formula 4 is present in Table 4 below:

TABLE 4

| Ingredient | Amount (%) |
|---|---|
| Moisture | 77.1-78.9 |
| Protein | 3.3-4.2 |
| Fat | 5.2-7.4 |
| Ash | 0.7-1.2 |
| NFE | 10.8-11.1 |

In each instance, the meat source, dry ingredients and water were mixed in a bowl and then heated to a temperature of approximately 100° F. At that point, an amylase was added to the test compositions and then heated to a temperature of 170° F. (amounts and types of amylase added to each as in Table 5.) The amylases used were a temperature-labile bacterial alpha-amylose of Bacillus amyloliquefaciens ((BAN 480 L®) and a temperature-stable bacterial alpha-amylase of Bacillus licheniformis (Termanyl® Classic); both are available from Novozymes (Denmark).

After the mixture was heated to 170° F., samples of each product were distributed to 12-ounce cans that were sterilized at 250° F. for 73 minutes. All of the samples were aged for at least 14 days before the texture was measured using a TA-TX2 Texture Analyzer (Texture Technologies Corporation, Scarsdale, N.Y.) generally according to the manufacturer's instructions.

The control compositions were prepared in the same manner and with the same amounts of ingredients as the test compositions with the exception of no added amylase.

The texture data obtained for each of Formulations 1-4, with and without partial digestion with each enzyme, are summarized in Table 5 below.

TABLE 5
Texture Determination: Applied Force for Penetration

| | | | Difference in |
|---|---|---|---|
| | | | Force: Test |
| | | | Formulation v. |
| Composition | Treatment | Force (g) | Control (%) |
| Formulation 1 | Control | 1109.1 | |
| | 0.001% Termamyl classic | 455.8 | 59 |
| | 0.005% Termamyl classic | 140.6 | 87 |
| Formulation 2 | Control | 755.1 | |
| | 0.001% BAN 480 L | 211.2 | 72 |
| | 0.005% BAN 480 L | 175.5 | 77 |
| Formulation 3 | Control | 897.6 | |
| | 0.001% BAN 480 L | 530.3 | 41 |
| | 0.005% BAN 480 L | 341.0 | 62 |
| Formulation 4 | Control | 1004.1 | |
| | 0.001% BAN 480 L | 512.2 | 49 |

The data above demonstrates that partial starch digestion of each amylase tested softened the texture of each of Formulations 1-4, as compared to the same formulation that had not been treated with an amylase. In each instance less force was required to penetrate the amylase-treated products as compared to the control. The data also demonstrated that the extent of softening and therefore the nature of the softened texture of the product can be controlled by varying the level of enzyme employed in the digestion reaction.

### Example 2

### Effect of pH on the Activity of the Amylases

The pH optima of both the BAN 480 L and Termamyl classic amylases are believed to be within the range of from about pH 5 to about pH 7. Accordingly, the pH of each of the final products above was determined to evaluate whether the pH was compatible with optimal enzyme activity. The data obtained are presented in Table 6 below:

TABLE 6

| Composition | Measured pH |
|---|---|
| Formula 1 | 5.6-5.7 |
| Formula 2 | 6.2-6.4 |
| Formula 3 | 6.2-6.4 |
| Formula 4 | 6.6-6.8 |

The data of Table 6 indicate that the pH of each of Formulations 1-4 was with the range that would be predicted for optimal activity of both the BAN 480 L and Termamyl classic alpha-amylases employed.

### Example 3

### Effect of Temperature on the Extent of Digestion with BAN 480 L

This experiment was carried out to determine the level of digestion observed at different temperatures. For this experiment, Formulation 1 (Example 1) was used as the substrate and BAN 480 L alpha-amylase as the amylase.

Different batches of the composition of Formulation 1 were prepared as described in Example 1. The enzyme, BAN 480 L alpha-amylase, was added to a level of 0.001% (of the total weight of the composition), and the individual samples were heated to a temperature of 120° F., 140° F., 158° F., 176° F. and 194° F. The control samples were also prepared as in Example 1 and heated to a temperature of 170° F. All samples were dispensed into cans, sealed, and sterilized as in Example 1. The extent of hydrolysis is indicated by the level of starch remaining and the total sugar levels observed and the data are presented in Table 7.

TABLE 7

| Temp. | Starch (%) | Total Sugars (%) |
|---|---|---|
| Control | 11.2 | 2.4 |
| 120° F. | 12.3 | 1.3 |
| 140° F. | 10.7 | 3.2 |
| 158° F. | 8.5 | 3.5 |
| 176° F. | 9.7 | 2.0 |
| 194° F. | 12.4 | 1.6 |

The data obtained demonstrate that, under these conditions, the maximum hydrolysis is observed at a temperature of 158° F. and that little hydrolysis is observed at a temperature above 180° F.

### Example 4

### Maximum Hydrolysis Temperature for Alpha-Amylase

As indicated in the preceding experiment, maximum hydrolysis is observed at a temperature of 140° F. to 160° F. An experiment was carried to determine the temperature at which this illustrative alpha-amylase would be inactivated, to allow preparation of a formulation that, after sterilization, would not include any residual, enzymatically-active alpha-amylase.

Different batches of the composition of Formulation 1 were prepared as described in Example 1. The enzyme, BAN 480 L alpha-amylase, was added to a level of 0.001% (of the total weight of the composition), and the individual samples were heated to a temperature of 160° F., 180° F., 190° F. and 200° F. The control samples were also prepared as in Example 1 and heated to a temperature of 170° F. All samples were dispensed into cans, sealed, and sterilized as in Example 1. The extent of hydrolysis is indicated by the level of starch remaining and the total sugar levels observed and the data are presented in Table 8.

TABLE 8

| Temp. | Starch (%) | Total Sugars (%) |
|---|---|---|
| Control | 12.0 | 1.6 |
| 160° F. | 10.0 | 2.3 |
| 180° F. | 12.4 | 0 |
| 190° F. | 12.9 | 0 |
| 200° F. | 13.2 | 0 |

The data above demonstrate that, under these conditions, the maximum hydrolysis is observed at a temperature of within the range of 140° F. to 160° F.

### Example 5

### Effect of Temperature and Time on Starch Hydrolysis

An experiment was carried out to determine the effects of both temperature and time on the degree of starch hydrolysis using an amylase. The model used involved a composition of Formulation 1 (Example 1) and BAN 480 L alpha-amylase as the amylase.

Different batches of the composition of Formulation 1 were prepared as described in Example 1. In this experiment, after the initial mixing at 100° F., BAN 480 L alpha-amylase was added at a level of 0.001% of the composition and the temperature of each of the individual batches of Formulation 1 was raised to the indicated temperature (i.e., 120° F., 150° F., and 180° F.) Samples were taken at the point where the indicated temperature was reached (“time zero”), and 30 and 60 minutes thereafter. The control samples were also prepared as in Example 1 and heated to 170° F. All samples were dispensed into cans, sealed, and sterilized as in Example 1. The extent of hydrolysis is indicated by the level of starch remaining and the total sugar levels observed and the data are presented in Table 9.

TABLE 9

| Temp and Time | Starch (%) | Total Sugars (%) |
|---|---|---|
| Control | 12.3 | 1.5 |
| 120° F./0 min. | 12.0 | 1.1 |
| 120° F./30 min. | 13.0 | 1.2 |
| 120° F./60 min. | 12.2 | 1.5 |
| 150° F./0 min. | 10.7 | 2.1 |
| 150° F./30 min. | 9.3 | 2.9 |
| 150° F./60 min. | 9.5 | 3.3 |
| 180° F./0 min. | 12.5 | 1.0 |
| 180° F./30 min. | 12.0 | 0.9 |
| 180° F./60 min. | 12.4 | 0.8 |

The data above demonstrate that optimal digestion of starch is observed at 150° F. within the range of 0 to 60 minutes under these conditions.

### Example 6

### Pet Food Composition Analyses After Curing and After Freeze/Thaw Cycles.

The composition of Formula 1 was prepared as described in Example 1. The grain mix, meat mix, and liquids were combined and blended to provide a homogenous mass and heated to a temperature of 100° F. to 110° F. before addition of the amylase as an aqueous solution to each sample to provide the intended final concentration of enzyme, i.e., 0.001%, 0.005%, 0.010%, 0.050% and 0.100% BAN 480 L alpha-amylase. Each of the blends, including the control blend without added amylase, was cooked at a temperature of 170° F.-175° F. After cooking, the mixtures were pumped to a can line seamer/filler by means of a pump and distributed to 12 ounce cans before retorting at 250° F. for 73 minutes.

After curing the product for two weeks, the texture of each of the samples was measured with a TA-XT2 Analyzer (Texture Technologies Corporation, Scarsdale, N.Y.) generally according to the manufacturer's instructions.

Additional samples of the cured compositions were subjected to three freeze/thaw cycles, in order to induce starch retrogradation. The texture of the samples treated in this manner were again analyzed as above. The control sample had become dry and crumbly after these treatments, and exhibited a much harder texture. The data obtained are presented in Table 10.

TABLE 10

| | Force (g) | Difference in | | Difference in |
|---|---|---|---|---|
| | Required for | Force: Test | Force (g) | Force: Test |
| | Penetration | Formulation | Required for | Formulation |
| Sample | Two week | v. Control | Penetration | v. Control |
| (% α-Amylase) | curing | (%) | Freeze/Thaw | (%) |
| Control | 1001 | | 1900 | |
| 0.001% | 961 | 4 | 1409 | 26 |
| 0.005% | 872 | 13 | 1483 | 22 |
| 0.010% | 264 | 74 | 855 | 55 |
| 0.050% | 219 | 77 | 500 | 74 |
| 0.100% | 187 | 81 | 600 | 68 |

The data of Table 10 demonstrate that addition of alpha-amylase provided a soft-texture pet food composition as compared to the control samples, since the latter samples required a greater amount of force to penetrate the structure of the composition.

### Example 7

### Digestibility Studies

Digestibility studies were carried out using the composition of Formula 1 (Example 1) digested with either 0.01%, 0.05%, or 0.10% BAN 480 L, according to standard procedures. Six dogs were fed the indicated diet for 14 days and fecal output collected on days 11 through 14. Both diet and feces were analyzed for protein, fat, fiber, ash, nitrogen free extract (“NFE”), and energy. The data are expressed as a percentage of recovered material as compared to the diet fed and are presented in Table 11.

TABLE 11

| | Expected | | Alpha-Amylase Level | | |
|---|---|---|---|---|---|
| Digestibility | Values | Control | 0.01% | 0.05% | 0.10% |
| Dry matter (%) | 65 | 74.5 | 76.0 | 71.1 | 71.3 |
| True Protein (%) | 70 | 79.8 | 78.8 | 80.0 | 79.6 |
| Energy (%) | 65 | 73.9 | 76.7 | 73.3 | 73.5 |
| Vital Nutrients (%) | 75 | 83.5 | 84.5 | 81.7 | 81.8 |

The data of Table 11 demonstrate that the soft-texture pet food compositions of the present disclosure exhibit digestibility properties substantially equivalent to the untreated controls.

### Example 8

### Stool Studies

Stool studies were conducted, comparing the pet food composition of Formula 1 (Example 1) either without (control) or with starch digestion carried out as in Example 1 using 0.01%, 0.05%, and 0.10% BAN 480 L as the amylase. The stool studies were carried out with 10 animals fed a maintenance level of each formulation. The stools are scored on a scale of 1 to 5, with values of 3 or higher being preferred. The data obtained are presented in FIG. 10 and Table 12.

TABLE 12

Stools Rating

| Sample | 1 & 2 | 3 | 4 | 5 |
|---|---|---|---|---|
| Control | 0 | 3.6 | 28.6 | 67.9 |
| 0.01% α-amylase | 1.9 | 3.7 | 35.2 | 59.3 |
| 0.05% α-amylase | 3.5 | 0 | 29.8 | 66.7 |
| 0.10% α-amylase | 1.7 | 1.7 | 20.3 | 76.3 |

The data of Table 12 demonstrate that feeding the animals the soft-textured pet food compositions of the present disclosure resulted in the production of comparable stools as compared to those produced by animals fed the control composition.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active matter of the material.

What is claimed is:

1. A pet food composition comprising:
from about 10% to about 60% protein on a dry matter basis;
from about 5% to about 40% fat on a dry matter basis; and
from about 30% to about 65% carbohydrate on a dry matter basis; and
at least one amylase, wherein the amylase is a temperature-labile amylase;
wherein the pet food composition has a soft texture;
wherein the pet food composition has a penetrating force that is within the range of from about 10% to about 80% of that of a pet food composition without added amylase; and
wherein the composition comprises substantially no enzymatically-active amylase.

2. The pet food composition of claim 1 wherein the amylase is an endo-amylase, an exo-amylase, or mixtures thereof.

3. The pet food composition of claim 1 or claim 2, wherein the amylase is present in an amount from about 0.001% to about 0.1% of the total weight of the mixture.

4. The pet food composition of any preceding claim, wherein the amylase is present in an amount from about 0.005% to about 0.5% of the total weight of the mixture.

5. The pet food composition of any preceding claim, wherein the pet food composition is nutritionally or organoleptically adapted for a companion animal.

6. The pet food composition of claim 5, wherein the companion animal is a canine or feline.

7. The pet food composition of any preceding claim, wherein the pet food composition has a penetrating force that is within the range of from about 10% to about 60% of that of a pet food composition without an added amylase.

8. The pet food composition of claim 7, wherein the pet food composition has a penetrating force that is within the range of from about 10% to about 40% of that of a pet food composition without an added amylase.

9. The pet food composition of any preceding claim, wherein the composition is a wet pet food composition comprising from about 30% to about 80% water.

10. The wet pet food composition of claim 9, wherein the wet pet food composition comprises from about 40% to about 60% water.

11. A process for preparing a pet food composition, the process comprising:
a) preparing a mixture comprising water, from about 10% to about 60% protein on a dry matter basis, from about 5% to about 40% fat on a dry matter basis, and from about 30% to about 65% carbohydrate on a dry matter basis;
b) contacting the mixture with an effective amount of an amylase, and heating to a temperature from about 120° F. to about 220° F. for a time sufficient to provide an amylase-treated mixture; and
c) retorting the amylase-treated mixture; and
wherein the pet food composition has a soft texture.

12. The process of claim 11, wherein the amylase is an endo-amylase, an exo-amylase, or mixtures thereof.

13. The process of claim 11 or claim 12, wherein the amylase is present in an amount within a range of from about 0.001% to about 0.1% of the total weight of the mixture.

14. The process of claim 13, wherein the amylase is present in an amount within a range of from about 0.005% to about 0.5% of the total weight of the mixture

15. The process of any one of claims 11-14, wherein the mixture comprises water in an amount within a range of from about 30% to about 80% of the total weight of the mixture.

16. The process of claim 15, wherein the mixture comprises water in an amount within a range of from about 40% to about 60% of the total weight of the mixture.

17. The process of any one of claims 11-16, wherein the temperature is within a range of from about 140° F. to about 200° F.

18. The process of any one of claims 11-17, wherein the amylase is a temperature-labile endo-amylase, exo-amylase, or mixture thereof.

19. The process of claim any one of claims 11-18, wherein the amylase is a temperature-stable endo-amylase, exo-amylase, or mixture thereof.

20. A soft-textured pet food composition prepared according to the process of claim 11.

21. The soft-textured pet food composition of claim 20, wherein the composition is nutritionally or organoleptically adapted for a companion animal.

22. The soft-textured pet food composition of claim 21, wherein the companion animal is a canine or a feline.
